(19) United States
(12) Patent Application Publication
(10) Pub. No.: US 2004/0031064 A1
(43) Pub. Date: Feb. 12, 2004

(54) Cable receiver having in-band and out-of-band tuners

(75) Inventors: Mats Lindstrom, San Diego, CA (US); Glenn W. Eswein, Branchburg, NJ (US); Abdolreza Shafie, San Diego, CA (US); Mike A. Ploof, San Diego, CA (US); Ryuji Maeda, San Diego, CA (US); Manjit S. Gill, San Diego, CA (US); Eileen Carlson, San Diego, CA (US); Anthony R. Simon, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: Conexant Systems, Inc.

(21) Appl. No.: 10/214,960

(22) Filed: Aug. 8, 2002

(51) Int. Cl. H04N 7/16

(52) U.S. Cl. 725/150; 725/151; 725/146

(57) ABSTRACT

A cable television receiver includes in-band and out-of-band tuners integrated on a single IC. A mode controller determines whether an out-of-band signal is being received and powers the out-of-band tuner off when no out-of-band signal is present. A signal divider divides the signals between the in-band and out-of-band tuners and may be an asymmetric coupler in order to provide a higher power signal to the in-band tuner and a lower power signal to the out-of-band tuner.

### FIELD OF THE INVENTION

The present invention relates to a cable television receiver and, more particularly, relates to a cable television receiver having in-band and out-of-band tuners on a single integrated circuit.

### BACKGROUND OF THE INVENTION

The recent advent of subscriber home terminals, such as digital set top boxes, has enabled cable operators to offer subscribers a wide array of broadband content beyond the usual cable television programming. Electronic and interactive programming guides can be received and displayed on the subscriber's television via the set top box. Pay-per-view and video-on-demand programming may be directly purchased via the subscriber's interface with the set top box. High speed Internet access and email services may be provided. Numerous other applications such as interactive games, IP telephony and videophone services are envisioned.

In order to support the receipt and display of this multitude of broadband content, the set top box receiver typically includes at least two separate tuners. A first type of tuner, designated an “in-band” (IB) tuner, has the primary function of receiving and tuning cable television channels. Each channel typically has a fixed width of 6 or 8 MHz and is located in the 50-850 MHz frequency band. A second type of tuner, designated an “out-of-band” (OOB) tuner is used to receive data and digital content. This content may include programming guides, video-on-demand and pay-per-view programming, Internet data and so on. The presence of multiple tuners permits simultaneous display of cable television programming along with other digital content. Internet data received over the out-of-band tuner may be displayed on one portion of the television display, for example, while a selected television channel is displayed on another portion of the display.

Modern subscriber home terminals employ separate out-of-band and in-band tuners in order to receive both in-band and out-of-band channels. These separate tuners are a costly part of such receivers. Cost advantages could be obtained by combining the in-band and out-of-band tuner functionality on a single integrated circuit.

### SUMMARY OF THE INVENTION

The present invention provides a receiver having an in-band tuner and an out-of-band tuner integrated on a single IC. In one implementation of the invention, the receiver is a cable television receiver and a mode controller is provided for powering the out-of-band tuner on when an out-of-band signal is present and powering the out-of-band tuner off when no out-of-band signal is present. In a further implementation, a signal divider is provided to divide the received RF signal either symmetrically or asymmetrically between the two tuners.

In another embodiment of the invention, a cable set top box is provided. The set top box includes an in-band tuner and an out-of-band tuner integrated on a single IC. A mode controller powers the out-of-band tuner on when an input RF signal on an out-of-band channel is received, and powers the out-of-band tuner off when an input RF signal on an out-of-band channel is not received. In one implementation, a coupler divides the input RF signal asymmetrically between the in-band tuner and the out-of-band tuner, providing a relatively higher power signal to the in-band tuner and a relatively lower power signal to the out-of-band tuner.

The present invention also provides a method for tuning in-band and out-of-band cable channels on a single IC. An input RF signal is received and provided to both an in-band and an out-of-band tuner. If the input signal is on an out-of-band channel, the out-of-band tuner is powered on and, if the input signal is not on an out-of-band channel, the out-of-band tuner is powered off.

A further embodiment of the invention is a cable television receiver having in-band and out-of-band tuning means. Mode control means powers the out-of-band tuning means on when RF signals on out-of-band channels are received, and powers the out-of-band tuning means off when RF signals on the out-of-band channels are not received. Signal divider means divides the RF signals between the in-band tuning means and the out-of-band tuning means.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrates a tuner IC having integrated in-band and out-of-band tuners according to the present invention.

FIG. 2 is a schematic diagram of a typical single-conversion tuner architecture.

FIG. 3 is a schematic diagram of a typical dual-conversion tuner architecture.

FIG. 4 is a flow chart illustrating a method for switching a tuner between in-band and out-of-band modes according to the present invention.

### DETAILED DESCRIPTION

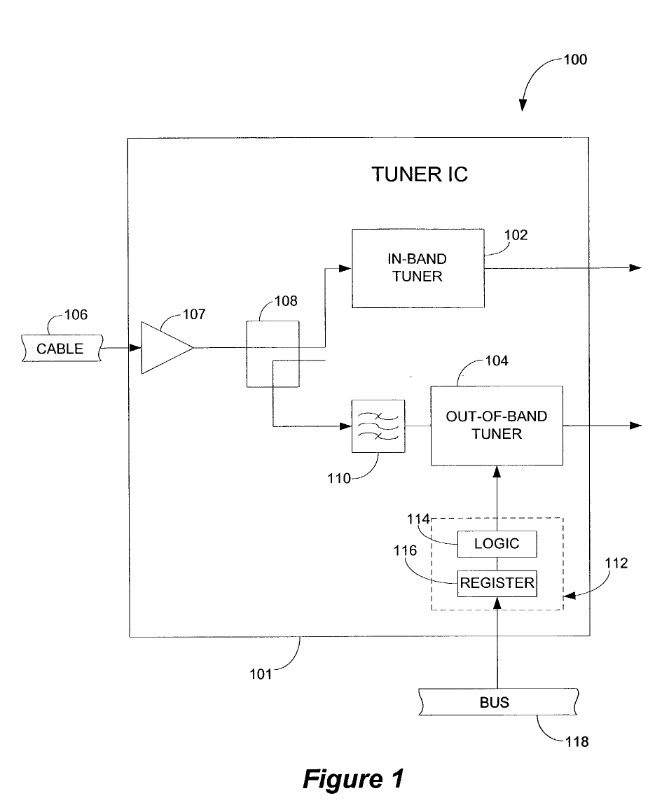

FIG. 1 is a block diagram of a first embodiment of the present invention. Tuner integrated circuit (IC) 100 is integrated on a single semiconductor chip 101 and comprises an in-band (IB) tuner 102 and an out-of-band (OOB) tuner 104. In one implementation, tuner IC 100 is contained in a subscriber home terminal such as a cable set top box. Functionally, tuner IC 100 is a single component or module mountable on a printed circuit board with its signal inputs and outputs coupled to the appropriate signal lines within the set top box or other receiving system in which it is incorporated. Tuners 102 and 104 are appropriately isolated from each other by being placed as remotely as feasible from each other on chip 101 and/or by use of an appropriate isolation structure such as a guard ring or trench.

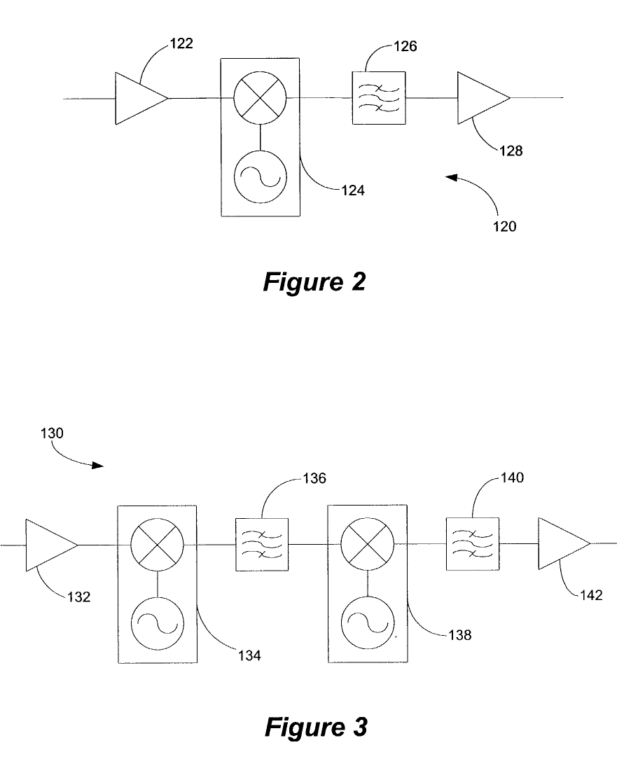

In-band tuner 102 is used primarily to receive and downconvert RF signals containing cable TV channels to an intermediate frequency (IF). In-band tuner 102 may also receive supplemental data or digital content, such as programming guides and information. The in-band channels are typically in the 50-850 MHz frequency range, and within that range, each channel typically occupies a fixed frequency band of 6 or 8 MHz. It may have a single-conversion (FIG. 2), dual-conversion (FIG. 3) or other architecture, as is appropriate to the particular implementation. Where possible, a single-conversion architecture is preferred as component count and costs are reduced.

Out-of-band tuner 104 is used primarily to receive and downconvert narrowband data and digital signals to an intermediate frequency (IF). The out-of-band channels received by tuner 104 are typically located in the 70-130 MHz frequency range and, within that range, each channel occupies a relatively narrower frequency band of 3 MHz or less. Examples of the types of signals that may be carried on the out-of-band channels received by tuner 104 include, but are not limited to, Internet data, video-on-demand and pay-per-view programming, interactive programming guides, interactive games and IP telephony and videophone signals. As with in-band tuner 102, tuner 104 may use any architecture that is appropriate to the particular application, including single-conversion (FIG. 2) and dual-conversion (FIG. 3) architectures. Where possible, a single-conversion architecture is preferred as component count and costs are reduced.

RF signals received over input cable line 106 are provided to both in-band tuner 102 and out-of-band tuner 104. Alternatively, tuners 102 and 104 may receive in-band and out-of-band signals from other RF signal transmission mediums, such as wireless transmission. The input RF signal is amplified by LNA 107 and then supplied to signal divider 108. Signal divider 108 is used to route the input RF signal to both tuners. LNA 107 and signal divider 108 may be on-chip, as illustrated, or may be off-chip.

In the illustrated embodiment, divider 108 comprises a coupler that divides the power unequally or asymmetrically between tuners 102 and 104. Use of a coupler is advantageous as the power requirements for tuning out-of-band digital signals are less than the power requirements for tuning in-band analog broadcast signals. Hence, coupler 108 may be configured to provide a higher power signal to in-band tuner 102 and a lower power signal to out-of-band tuner 104. In an alternate embodiment, signal divider 108 comprises a symmetrical splitter that divides the power of the input RF signal equally between tuners 102 and 104.

The signal directed to out-of-band tuner 104 is first routed through band pass filter 110 in order to limit the signal provided to tuner 104 to narrowband signals within the desired frequency band. In one embodiment, filter 110 passes signals in the 70-130 MHz band and rejects all other signals. Filter 110 may be located on- or off-chip; however, the size of filter 110 may dictate that it be located off-chip.

Tuner IC 100 also includes a mode controller 112 coupled to out-of-band tuner 104 for powering out-of-band tuner 104 on or off, depending on whether out-of-band signals are being received. Hence, mode controller 112 will typically be coupled to the bias inputs of some or all of the components within out-of-band tuner 104, and will reduce the bias input current to zero when no out-of-band signal is present and set the bias current to an appropriate level when an out-of-band signal is present. Mode controller 112 may be a part of the mode controller for in-band tuner 102, or may be implemented as a separate controller.

In one implementation, mode controller 112 is controlled by an off-chip computer, processor or software via an interface with bus 118. Bus 118 may have a parallel or serial configuration. In one implementation, mode controller 112 includes internal registers 116 whose values are updated via bus 118 depending on whether an out-of-band signal is being received. Logic circuitry 114 coupled to registers 116 powers the various components (described below) of tuner 104 on or off based on the values stored in registers 116. This is just one embodiment of an out-of-band mode controller; other embodiments are possible and are within the scope of this invention.

As indicated above tuners 102 and 104 may be configured with any architecture that is appropriate to the particular application. FIG. 2 and FIG. 3 depict two potential tuner architectures for tuners 102 and 104: a single-conversion tuner 120 and a dual-conversion tuner 130.

Single-conversion tuner 120 (FIG. 2) comprises low noise amplifier (LNA) 122, frequency conversion stage 124, IF filter 126 and IF amplifier 128. LNA 122 amplifies the received RF signal a fixed amount with minimal noise amplification. As an alternative to a fixed gain amplifier, a variable gain amplifier or a fixed gain amplifier in series with a variable gain attenuator may be used. The output of LNA 122 is coupled to frequency conversion stage 124, which comprises a mixer and local oscillator. Frequency conversion stage generates a signal at an intermediate frequency (IF) by mixing the input signal with the local oscillator signal. The IF signal is coupled to IF filter 126, which is typically a band pass filter that selects a band of channels or a single channel. The output of filter 126 is passed to IF AGC amplifier 128, which further controls the overall tuner gain. The output of amplifier 128 is then subjected to further processing and/or filter in a known manner to provide IF audio and video signals.

A direct-conversion tuner, rather than a single-conversion tuner, could also be used. A direct-conversion tuner would be similar to single-conversion tuner 120, but would convert the input RF signal to baseband rather than to an intermediate frequency, and would us a low pass filter in place of band pass filter 126.

Dual-conversion tuner 130 (FIG. 3) comprises LNA 132, first frequency conversion stage 134, first IF filter 136, second frequency conversion stage 138, second IF filter 140 and IF AGC amplifier 142. LNA 132 amplifies the received RF signal with minimal noise amplification. The output of LNA 132 is coupled to first frequency conversion stage 134, which up-converts the input RF signal to a signal IF1 at a first intermediate frequency that is typically higher than the input RF frequency. The IF1 signal is coupled to first IF filter 136, which is typically a band pass filter that selects a band of channels or a single channel. The output of filter 136 is passed to second frequency conversion stage 138, which down-converts the IF1 signal to a signal IF2 at a second intermediate frequency that is typically lower than the input RF frequency. The output signal IF2 is then passed through a second IF filter 140 and IF AGC amplifier 142.

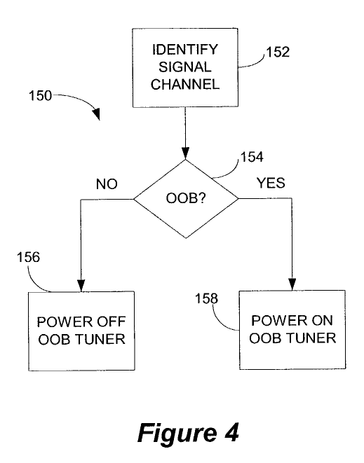

FIG. 4 illustrates a method 150 for switching out-of-band tuner 104 between an on state and an off state depending on whether out-of-band signals are being received. In step 152, the incoming signal channel is identified. With reference to FIG. 1, step 152 is carried out by communication of the signal channel (in-band or out-of-band) from bus 118 to mode controller 112, with values corresponding to the signal channel type being stored in register 116. If an out-of-band signal is not being received (step 154), mode controller 112 powers tuner 104 off (step 156). In one implementation, logic circuitry 114 powers tuner 104 off by reducing the input bias current to the components of tuner 104 to zero. If an out-of-band signal is being received (step 154), mode controller 112 powers tuner 104 on (step 158). In one implementation, logic circuitry 114 powers tuner 104 on by setting the input bias current to the components of tuner 104 to an appropriate level.

While out-of-band tuner 104 is powered on, in-band tuner 102 may also be powered on, permitting simultaneous reception and display of in-band and out-of-band signals. Hence, digital content such as Internet data, video-on-demand options and the like received via out-of-band tuner 104 may be displayed in one portion of the viewable area, while broadcast programming received via in-band tuner 102 is simultaneously displayed in another portion of the viewable area. The incoming signal may be continuously monitored, so that out-of-band tuner 104 may be intermittently powered on and off as need to maximize power conservation.

While various embodiments of the invention have been described, it will be apparent to those of ordinary skill in the art that many more embodiments and implementations are possible that are within the scope of this invention.

What is claimed is:

1. A receiver comprising:
an in-band tuner; and
an out-of-band tuner, wherein the in-band and out-of-band tuners are integrated on a single IC.

2. A receiver as claimed in claim 1, wherein the receiver is a cable television receiver.

3. A receiver as claimed in claim 2 and further comprising a mode controller for powering the out-of-band tuner on when a signal on an out-of-band channel is received and for powering the out-of-band tuner off when a signal on an out-of-band channel is not received.

4. A receiver as claimed in claim 3, wherein the mode controller is coupled to the bias current input of at least one component of the out of band tuner, and wherein the bias current input is reduced to zero when no out-of-band signal is present and is increased to a positive value when an out-of-band signal is present.

5. A receiver as claimed in claim 4, wherein the mode controller comprises logic circuitry coupled to the out-of-band tuner; and a register coupled to the logic circuitry and storing programmed values appropriate to either power on or power off the out-of-band tuner.

6. A receiver as claimed in claim 2, and further comprising a signal divider for dividing an input RF signal between the in-band tuner and out-of-band tuner.

7. A receiver as claimed in claim 6, wherein the signal divider is a splitter that divides the input RF signal symmetrically between the in-band tuner and out-of-band tuner.

8. A receiver as claimed in claim 6, wherein the signal divider is a coupler that divides the input RF signal asymmetrically between the in-band tuner and the out-of-band tuner.

9. A receiver as claimed in claim 8, wherein the coupler provides a relatively higher power signal to the in-band tuner and a relatively lower power signal to the out-of-band tuner.

10. A receiver as claimed in claim 6, and further comprising a band pass filter coupled between the signal divider and the out-of-band tuner to reject RF signals that are not in an out-of-band channel.

11. A set top box comprising a cable television receiver as claimed in claim 2.

12. A cable television receiver comprising:
an in-band tuner and an out-of-band tuner, wherein the in-band and out-of-band tuners are integrated on a single IC;
a mode controller for powering the out-of-band tuner on when an input RF signal on an out-of-band channel is received, and for powering the out-of-band tuner off when an input RF signal on an out-of-band channel is not received; and
a coupler that divides the input RF signal asymmetrically between the in-band tuner and the out-of-band tuner, providing a relatively higher power signal to the in-band tuner and a relatively lower power signal to the out-of-band tuner.

13. A method for tuning in-band and out-of-band cable channels on a single IC comprising:
receiving an input RF signal;
providing the input RF signal to an in-band tuner and to an out-of-band tuner;
detecting whether an input signal is on an out-of-band channel;
if the input signal is on an out-of-band channel, powering the out-of-band tuner on; and
if the input signal is not on an out-of-band channel, powering the out-of-band tuner off.

14. A method as claimed in claim 13, and further comprising the step of dividing the input RF signal into first and second signals, wherein the first signal is a signal of relatively higher power that is provided to the in-band tuner and the second signal is a signal of relatively lower power that is provided to the out-of-band tuner.

15. A cable television receiver comprising:
in-band tuning means for tuning RF signals received on in-band channels;
out-of-band tuning means for tuning RF signals received on out-of-band channels;
mode control means for powering the out-of-band tuning means on when RF signals on the out-of-band channels are received, and for powering the out-of-band tuning means off when RF signals on the out-of-band channels are not received; and
signal divider means for dividing the RF signals between the in-band tuning means and the out-of-band tuning means.

16. A cable television receiver as claimed in claim 15, wherein the signal divider means asymmetrically divides the RF signals.

17. A cable television receiver as claimed in claim 16, wherein the signal divider means provides a relatively higher power signal to the in-band tuner and a relatively lower power signal to the out-of-band tuner.

18. A cable television receiver as claimed in claim 15, wherein the signal divider means symmetrically divides the RF signals.

19. A method for tuning in-band and out-of-band cable frequency channels on a single IC comprising:
a step for receiving an input RF signal;
a step for dividing the input RF signal between an in-band tuner and an out-of-band tuner;
a step for powering the out-of-band tuner on if the input signal is on an out-of-band channel; and
a step for powering the out-of-band tuner off if the input signal is not on an out-of-band channel.

20. A method as claimed in claim 19, wherein the power level of the divided signal provided to the out-of-band tuner is lower than the power level of the divided signal provided to the in-band tuner.
